(19) United States
(12) Patent Application Publication
(10) Pub. No.: US 2007/0171299 A1
(43) Pub. Date: Jul. 26, 2007

(54) Automatic linear-motion and tilt-angle control apparatus for an image-capture device inside a photography light box

(75) Inventor: Peng-Cheng Lai, Panchian (TW)

Correspondence Address: BIRCH STEWART KOLASCH & BIRCH, PO BOX 747, FALLS CHURCH, VA, 22040-0747, US

(73) Assignee: Ortery Technologies, Inc.

(21) Appl. No.: 11/339,448

(22) Filed: Jan. 26, 2006

(51) Int. Cl. H04N 5/225

(52) U.S. Cl. 348/373

(57) ABSTRACT

The present invention discloses an automatic linear-motion and tilt-angle control apparatus for an image-capture device inside a photography light box, which includes: a photography light box, a linear-motion module, a rotation module, and a fixing seat. The linear-motion module further includes: servo motors, ball screws, linear sliding rails and a sliding table to implement the horizontal and vertical motions of an image-capture device inside the photography light box. The rotation module includes: stepping motors, worm gears, and worm wheels to rotate the image-capture device when the linear-motion module moves the image-capture device horizontally, and tilts the image-capture device when the linear-motion module moves the image-capture device vertically to an appropriate height so that the image-capture device can be aimed at the object. The fixing seat is used to fix the image-capture device and disposed on a rotation table in an emptied hole.

### BACKGROUND OF THE INVENTION

1. Field of the Invention

The present invention relates to an automatic linear-motion and tilt-angle control apparatus for an image-capture device inside a photography light box, particularly to an automatic image-capture device, which could be integrated with a multi-function peripheral.

2. Description of the Related Art

The current MFP (Multi-Function Peripheral) can scan and copy a planar image and then faxes or prints it, but the current MFP still unable to capture an image of 3-D object yet in a photography light box. Other than the problem of how to integrate the light-box illumination and the image-capture device, there still has a critical problem of how to move and tilt the image-capture device inside the photography light box without interfering with the photographic path of the image-capture device. Traditionally, the top shot or side shot of the photography light box are executed manually. For example, when performing a top shot, a digital camera is locked by a clamp fixture sitting on a photography light box or fitted into a camera compartment of the photography light box or fixed to an arm-type tripod to shoot an object from the top of the photography light box; when performing a side shot, the digital camera is fixed to the tripod to adjust its height and tilting angle.

To realize a full automatic MFP, the conventional manually-operated image-capture device should be replaced by an automatic linear motion and tilt angle control of an image-capture device is critical to fully control a MFP which also includes photography feature. Therefore, the present invention proposes an automatic linear-motion and tilt-angle control apparatus for an image-capture device inside a photography light box is important to a MFP featuring with photography capability.

### SUMMARY OF THE INVENTION

One of objects of the present invention is to provide an automatic linear-motion and tilt-angle control apparatus for an image-capture device inside a photography light box, which could be integrated a full automatic image-capture system with MFP.

Another one of objects of the present invention is to provide an automatic linear-motion and tilt-angle control apparatus for an image-capture device inside a photography light box, wherein a linear-motion module, a rotation module, and an image-capture device are controlled by a computer via USB (Universal Series Bus) to implement an fully automatic image-capture system.

Further one of objects of the present invention is to provide an automatic linear-motion and tilt-angle control apparatus for an image-capture device inside a photography light box, wherein a linear-motion module is used to reduce the working space needed by the image-captured device inside a photography light box and provide the flexible photographic path of the image-capture device, and wherein a rotation module is used to rotate or tilt the image-capture device so that top shots and side shots can be efficiently executed in the limited space of the photography light box.

To achieve the abovementioned objectives, the present invention proposes an automatic linear-motion and tilt-angle control apparatus for an image-capture device inside a photography light box, which includes: a photography light box, a linear-motion module, a rotation module, and a fixing table of image-capture device, wherein the linear module further includes: servo motors, ball screws, linear sliding rails and a sliding table to implement the horizontal and vertical motions of an image-capture device inside the photography light box; the rotation module further includes: stepping motors, worm gears, and worm wheels to rotate the image-capture device when the linear-motion module moves the image-capture device to horizontal end, and tilts the image-capture device when the linear-motion module moves the image-capture device vertically to an appropriate height so that the image-capture device can be aimed at the object; the fixing table is a rotation table in an emptied hole and used to fix the image-capture device.

### BRIEF DESCRIPTION OF THE DRAWINGS

FIG. 1 is a diagram schematically showing the system control and the architecture according to the present invention.

FIG. 2 is a diagram schematically showing the side view of the mechanism of the present invention.

FIG. 3 is a diagram schematically showing the top view of the mechanism of the present invention.

### DETAILED DESCRIPTION OF THE INVENTION

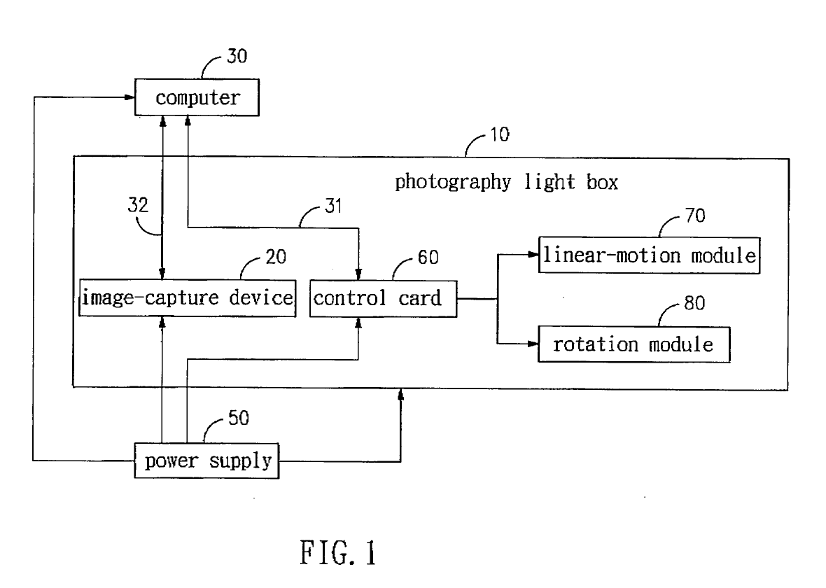

Refer to FIG. 1 a diagram schematically showing the system control and the architecture of the automatic linear motion and tilt angle control apparatus for an image-capture device inside a photography light box of the present invention. The present invention includes: a photography light box 10, an image-capture device 20, a linear-motion module 70, a rotation module 80, and a control card 60, which are all contained inside the photography light box 10. A 3-D turntable can be contained in an accommodation space of the photography light box 10 and used to implement the rotation of a photographed object to create a 3-D image. The image-capture device 20, which may be a digital camera, a CCD camera, or a web cam, is connected to a computer 30 via a signal cable 32. The linear-motion module 70 implements the linear motion of the image-capture device 20, and the rotation module 80 implements the rotation of the image-capture device 20. The control card 60 is connected to the linear-motion module 70 and the rotation module 80 to control the revolutions of the linear-motion module 70 and the rotation module 80. The control card 60 is also connected to the computer 30 via a signal cable 31. The signal cable 31 and 32 may be USB signal cables, IEEE1394 cables, RS232 signal cables or other signal cables. The computer 30 may be a PLC (Programmable Logic Controller) or another controller. A power supply 50 provides power for the computer 30, the image-capture device 20, the control card 60, and the photography light box 10.

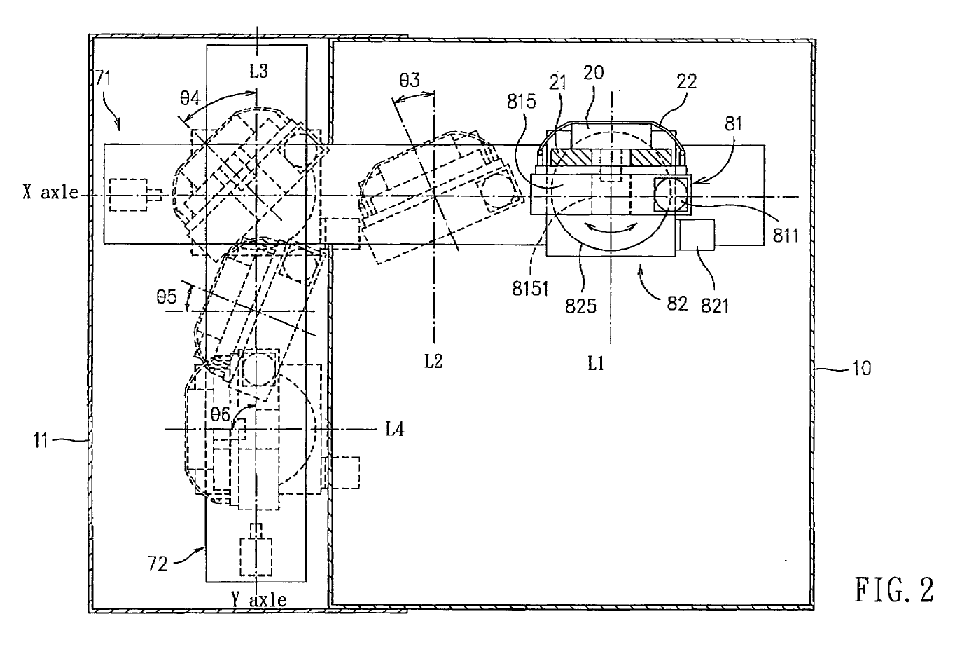

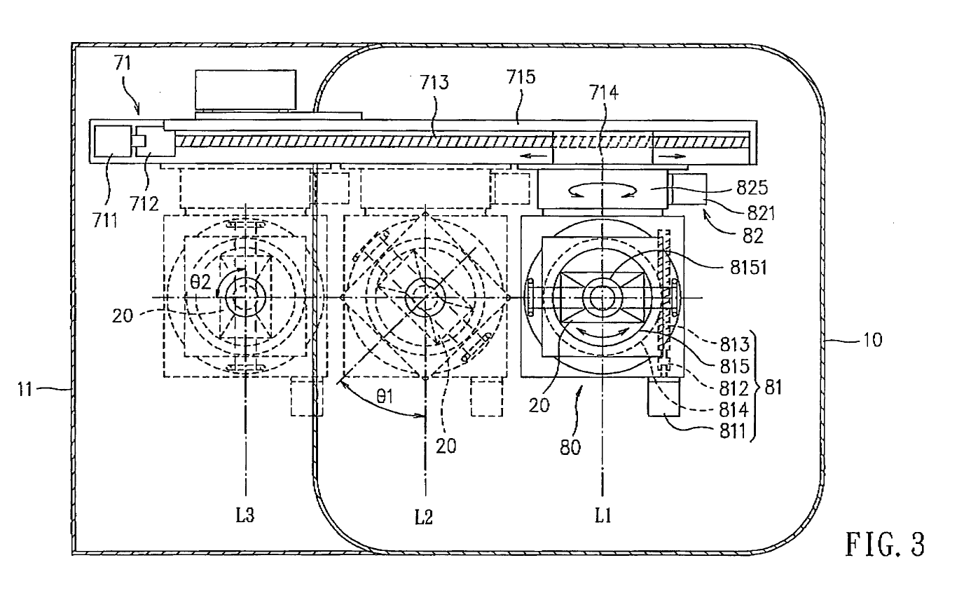

Refer to FIG. 2 and FIG. 3 diagrams respectively showing the side view and the top view of the mechanism of the present invention. The linear-motion module 70 is composed of a horizontal motion module 71 and a vertical motion module 72 perpendicular to the horizontal motion module 71. The horizontal motion module 71 is disposed in the inner side of the ceiling of the photography light box 10, and the vertical motion module 72 is disposed in the outer side of the side plate of the photography light box 10. A side coverage 11 is installed to the outer side of the side plate of the photography light box 10 to cover the vertical motion module 72. Otherwise, according to the shape and the dimension of the photography light box 10, the horizontal motion module 71 may be disposed in the outer side of the ceiling of the photography light box 10, and the vertical motion module 72 is disposed in the inner side or outer side of the side plate of the photography light box 10, and the side coverage 11 may be installed to the outer side of the side plate of the photography light box 10 to protect the vertical motion module 72. Due to the similarity of the structures of the horizontal motion module 71 and the vertical motion module 72, only the horizontal motion module 71 is to be described below. The horizontal motion module 71 includes: a servo motor 711, a coupling 712, a ball screw 713, a sliding table 714 and a linear sliding rail 715. The mount platform 825 of the image-capture device 20 is sitting on the sliding table 714, and the sliding table 714 can slide linearly on the linear sliding rail 715. When the servo motor 711 rotates and actuates the ball screw 713 to spin via the coupling 712, the ball screw 713 drives the sliding table 714 together with the mount platform 825 to move, means the image-capture device 20 is driven by the horizontal motion module 71 to move horizontally. Similarly, the image-capture device 20 may also be driven by the vertical motion module 72 to move vertically. Thereby, the image-capture device 20 may move along the X-axis direction or the Y-axis direction.

Refer to FIG. 2 and FIG. 3 again. According to the present invention, the rotation module 80 is composed of a first drive module 81 and a second drive nodule 82 vertical to the first drive module 81. Due to the similarity of the first drive module 81 and the second drive module 82, only the first drive module 81 is to be described below. The first drive module 81 includes a stepping motor 811, a coupling 812, a worm gear 813, a worm wheel 814 and a mount platform 815. The central portion of the mount platform. 815 is emptied to a hole 8151; a pad 21 and a Velcro 22 is installed to the mount platform 815; the image-capture device 20 is placed on the pad 21 and fastened by the Velcro 22. And the pad 21 and the Velcro 22 consist the fixing table of the image-capture device 20 may be replaced by another clamp device or locking device, Further, the pad 20 may also be an adjustable fixing seat; such an adjustable fixing seat has four movable blocks; those four movable blocks may be radial toward the image-capture device 20 and clamp it; thereby, the adjustable fixing seat can adapt to various lens of image-capture devices. When the stepping motor 811 rotates and actuates the worm gear 813 to spin via the coupling 812, the worm gear 813 drives the worm wheel 814 together with the mount platform 815 to rotate, and the image-capture device 20 will also rotate together with the mount platform 815 of the first drive module 81. Similarly, the second drive module 82 can also drive the image-capture device 20 to rotate. Thus, the image-capture device 20 can rotate in two orientations, which are vertical to each other.

Refer to FIG. 2 and FIG. 3 again, and the linear motion and rotation of the image-capture device 20 is to be described below. The horizontal motion module 71 can drive the image-capture device 20 to linearly move from Position L1 to Position L2 and then to Position L3. During the process that the image-capture device 20 moves from Position L1 to Position L3, the stepping motors 811, and 812 can simultaneously drive the image-capture device 20 to rotate. As shown in FIG. 2, when the image-capture device 20 arrives at Position L2, the stepping motor 811 will drive the image-capture device 20 to rotate to a tilt angle θ1; when the image-capture device 20 arrives at Position L3, it will be rotated to have a rotation angle θ2 of 90 degrees. As shown in FIG. 3, when the image-capture device 20 arrives at Position L2, the stepping motor 821 drives the image-capture device 20 to tilt to a tilt angle θ3; when the image-capture device 20 arrives at Position L3, it will be tilted to have an angle θ4 of about 45 degrees. The tilt to the tilt angle θ1 or θ3 and the rotation to the rotation angle θ2 or θ4 can be performed simultaneously, and thus, when undertaking a side shot, the image-capture device 20 can be adjusted to aim at the object. Similarly, during the process that the vertical motion module 72 drives the image-capture device 20 to move from Position L3 to Position L4, the stepping motor 821 drives the image-capture device 20 to tilt to a tilt angle θ5. When the image-capture device 20 arrives at Position L4, it will be tilted to have a tilt angle θ6 and perpendicular to Y-axis. Also, the image-capture device 20 can be adjusted to aim at the object when undertaking a side shot.

Besides, the linear-motion module 70 may also utilize a circulating or open type of belt or a chain or cord to drive the image-capture device 20 to move linearly. Furthermore, the present invention may also utilize a nonlinear-motion module to replace the linear-motion module 70. In one embodiment of the present invention, the nonlinear-motion module utilizes a curved guiding rail or a curved gear rail to move an image-capture device from a top-shot position to a side-shot position, and it is also a realization of the spirit of the present invention.

In summary, the present invention proposes an automatic linear-motion and tilt-angle control apparatus for an image-capture device inside a photography light box, which integrates a photography light box, linear-motion module, a rotation module, and a fixing seat for image-capture devices, wherein a computer or PLC (Programmable Logic Controller) is used to control the operations of the linear-motion module, the rotation module and the image-capture device so that not only the image-capture device can be automatically positioned at an appropriate location and aimed at the object inside the photography light box, but also the photographic path can mininmize the interference during a side shot or a top shot, and thereby, the image-capture device can become part of MFP. Besides, the fixing seat can adapt to various lens of image-capture devices.

What is claimed is:

1. An automatic linear-motion and tilt-angle control apparatus for an image-capture device inside a photography light box, comprising:
a photography light box;
a linear-motion module, used to linearly move an image-capture device;
a rotation module, used to rotate and tilt said image-capture device; and
a fixing seat installed to said rotation module and used to mount and fix said image-capture device.

2. The automatic linear-motion and tilt-angle control apparatus for an image-capture device inside a photography light box according to claim 1, wherein said linear-motion module is composed of a horizontal motion module and a vertical motion module perpendicular to said horizontal motion module.

3. The automatic linear-motion and tilt-angle control apparatus for an image-capture device inside a photography light box according to claim 2, wherein said horizontal motion module is disposed in either the inner side or the outer side of the ceiling of said photography light box or at the ceiling of said photography light box.

4. The automatic linear-motion and tilt-angle control apparatus for an image-capture device inside a photography light box according to claim 3, wherein a side coverage or a top coverage is used to protect said horizontal motion module when said horizontal motion module is disposed in the outer side of the ceiling of said photography light box.

5. The automatic linear-motion and tilt-angle control apparatus for an image-capture device inside a photography light box according to claim 2, wherein said vertical motion module is disposed in either the inner side or the outer side of the side plate of said photography light box or at the side plate of said photography light box.

6. The automatic linear-motion and tilt-angle control apparatus for an image-capture device inside a photography light box according to claim 5, wherein a side coverage is used to protect said vertical motion module when said vertical motion module is disposed in the outer side of the side plate of said photography light box.

7. The automatic linear-motion and tilt-angle control apparatus for an image-capture device inside a photography light box according to claim 1, wherein said linear-motion module utilizes a circulating or open type of belt or a chain or a cord to drive said image-capture device to move linearly.

8. The automatic linear-motion and tilt-angle control apparatus for an image-capture device inside a photography light box according to claim 1, wherein said rotation module composed of a first drive module and a second drive module is driven by motors directly.

9. The automatic linear-motion and tilt-angle control apparatus for an image-capture device inside a photography light box according to claim 1, wherein said fixing seat is composed of a pad and a Velcro.

10. The automatic linear-motion and tilt-angle control apparatus for an image-capture device inside a photography light box according to claim 1, wherein said fixing seat is a clamping device or a locking device.

11. The automatic linear-motion and tilt-angle control apparatus for an image-capture device inside a photography light box according to claim 1, wherein a computer or a programmable logic controller or other controllers is used to control the operations of said linear-motion module, said rotation module, and said image-capture device.

12. The automatic linear-motion and tilt-angle control apparatus for an image-capture device inside a photography light box according to claim 1, further comprising a 3-D turntable disposed inside said photography light box.

13. An automatic nonlinear-motion and tilt-angle control apparatus for an image-capture device inside a photography light box, comprising:
a photography light box;
a nonlinear-motion module, utilizing a curved guiding rail or a curved gear rail to move an image-capture device from a top-shot position to a side-shot position;
a rotation module, used to rotate and tilt said image-capture device; and
a fixing seat installed to said rotation module and used to mount and fix said image-capture device.

14. The automatic nonlinear-motion and tilt-angle control apparatus according to claim 13, wherein said nonlinear-motion module is positioned at the ceiling or side plate or either in the inner side or the outer side of the ceiling or side plate of said photography light box.

15. The automatic nonlinear-motion and tilt-angle control apparatus according to claim 13, wherein said rotation module has a first set of drivers and a second set of drivers both directly driven by motors.
